(19) United States
(12) Patent Application Publication
(10) Pub. No.: US 2015/0081163 A1
(43) Pub. Date: Mar. 19, 2015

(54) OBD ILLUMINATOR CABLE APPARATUS AND METHOD

(71) Applicant: Service Solutions U.S. LLC, Warren, MI (US)

(72) Inventors: Lynn MOLENKAMP, Portage, MI (US); William W. WITTLIFF, III, Gobles, MI (US)

(73) Assignee: Service Solutions U.S. LLC, Warren, MI (US)

(21) Appl. No.: 14/026,414

(22) Filed: Sep. 13, 2013

(51) Int. Cl. H01R 13/717; H01R 13/629; H01R 13/641; G07C 5/00

(52) U.S. Cl. CPC H01R 13/7175; G07C 5/00; H01R 13/629; H01R 13/641
USPC 701/33.2; 439/374

(57) ABSTRACT

An on board diagnostic (OBD) II cable connector for use with an automobile diagnostic tool or the like. The on board diagnostic (OBD) II cable connector has a housing having an interface that extends from the housing. The interface engages an on board (OBD) II port on a vehicle using a series of pins extending therefrom. The on board diagnostic (OBD) II cable connector also includes a light source disposed upon the housing.

### FIELD OF THE DISCLOSURE

The present disclosure relates generally to an On-Board Diagnostic II (OBD II) cable to be used with automobiles or the like. More particularly, the present disclosure relates to an OBD II cable connector that illuminates and allows one to easily locate the OBD II cable connector of any vehicle.

### BACKGROUND

Recently manufactured vehicles are equipped with a special system called On-Board Diagnostic II (OBD II). On-board diagnostics, or OBD, is an automotive term referring to a vehicle's self-diagnostic and reporting capability. OBD systems give the vehicle owner and/or repair technician access to state of health information for various vehicle sub-systems. The amount of diagnostic information available via OBD has varied widely since the introduction in the early 1980s of on-board vehicle computers, which made OBD possible. Early instances of OBD would simply illuminate a malfunction indicator light or MIL, if a problem was detected but would not provide any information as to the nature of the problem. Modern OBD implementations use a standardized digital communications port to provide real-time data in addition to a standardized series of diagnostic trouble codes or DTCs, which allow one to rapidly identify and remedy malfunctions within the vehicle.

More specifically, OBD II monitors all engine and drive train sensors and actuators for shorts, open circuits, lazy sensors and out-of-range values as well as values that do not logically fit with other power train data. Thus, OBD II keeps track of all of the components responsible for engine operation and function and when one of them malfunctions, it signals the vehicle owner by illuminating a Maintenance Indicator Lamp (MIL), such as a check engine indicator as previously mentioned. It also stores Diagnostic Trouble Codes (DTCs) designed to help a technician find and repair the detected problem. OBD II also specifies the means for communicating diagnostic information to equipment used in diagnosing, repairing and testing the vehicle.

Prior to the current systems present in automobiles, it was made mandatory to provide an OBD II system in vehicles such as automobiles, to prevent air pollution. Initially, the OBD-II system provided a warning to a driver if a failure occurs in an exhaust gas control device. In such OBD-II systems, information regarding a failure is stored in non-volatile memory of an Electronic Control Unit (hereinafter, referred to as “ECU”). For example, an illuminated MIL indicated that the OBD II system has detected a problem that may cause increased emissions whereas blinking MIL indicates a severe engine misfire that can damage the catalytic converter.

Numerous diagnostic tools exist for servicing modern vehicles equipped with electronic control units (ECUs). The ECUs control the functioning of the various vehicle electronic subsystems such as, for example, transmission control units, electronic ignition systems, air bag systems, keyless entry systems, climate control systems and antilock braking systems. In order to control these electronic subsystems, the ECUs utilize data from various sensors provided throughout the vehicle such as, for example, oxygen sensors, air temperature sensors, throttle position sensors, knock sensors, coolant temperature sensors, and tire pressure monitoring sensors.

The ECUs of modern vehicles are also programmed to alert drivers to various safety and service conditions identified from data collected from the various sensors in the vehicles. Examples of such conditions include, but are not limited to, low tire pressure, recommended oil replacement interval exhausted, low battery charge, faulty oxygen sensor, failed mass airflow sensor and faulty gas cap. While many vehicles have display screens that provide information to a driver on the detection of a safety or service condition, in many vehicles having such ECUs the driver will be alerted to the existence of such a safety or service condition by the illumination of a “check engine” light.

The OBD II port for a vehicle varies from vehicle to vehicle and is not located in a standard position or location and therefore it is oftentimes difficult to locate the OBD II port on the vehicle without the assistance of additional tools. Additionally, most OBD II ports are located under the dashboard of the respective vehicle contributing to the difficulty in locating said ports as it is very dark and typically illumination is necessary to locate the OBD II port. Moreover, illumination is also required to ensure proper connection of the OBD II cable to the OBD II port.

Accordingly, it is desirable to provide an OBD II cable and connector that provides illumination that may be easily deployed in a confined space beneath a vehicle dashboard. Moreover, it is desirable to provide an OBD II cable and connector that provides illumination or the like that allows technicians to easily and efficiently locate the OBD II port of a vehicle without the need for additional tools, for example a flashlight, and ensure the OBD II cable is securely connected to the OBD II port of the vehicle.

### SUMMARY

In one embodiment of the present disclosure, an on board diagnostic (OBD) II cable connector for use with an automobile diagnostic tool or the like is provided, comprising: a housing having an interface that extends from said housing, a series of pins extending from said interface; and a light source disposed upon said housing.

In another embodiment of the present disclosure, a diagnostic system for running diagnostic tests or the like on a vehicle is provided, comprising: diagnostic tool, comprising: an input for receiving data associated with a vehicle; a microprocessor for processing said data received from the input and for instructing a search of repair assets corresponding to said data regarding the vehicle; a notification device for notifying a user of located repair assets; and a user interface for selecting repair assets to be provided to the user; an on board diagnostic (OBD) cable having a connector attached to said diagnostic tool, said connector comprising: a housing having an interface that extends from said housing, a series of pins extending from said interface; and a light source disposed upon said housing.

In yet another embodiment of the present disclosure, a method for connecting an OBD II cable to an OBD II port of a vehicle is provided, comprising: providing an on board diagnostic (OBD) cable connector, comprising: a housing having an interface that extends from said housing; a series of pins extending from said interface; a light source disposed upon said interface. powering on said light source; locating a OBD II port on the vehicle using the light source; inserting the cable connector into the OBD II port; and confirming insertion of the cable into the OBD II port.

There has thus been outlined, rather broadly, certain embodiments of the disclosure in order that the detailed description thereof herein may be better understood, and in order that the present contribution to the art may be better appreciated. There are, of course, additional embodiments of the disclosure that will be described below and which will form the subject matter of the claims appended hereto.

In this respect, before explaining at least one embodiment of the disclosure in detail, it is to be understood that the disclosure is not limited in its application to the details of construction and to the arrangements of the components set forth in the following description or illustrated in the drawings. The disclosure is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present disclosure. It is important, therefore, that the claims be regarded as including such equivalent constructions insofar as they do not depart from the spirit and scope of the present disclosure.

### BRIEF DESCRIPTION OF THE DRAWINGS

FIG. 1 is a front, perspective view of an OBD II cable connector in accordance with an embodiment of the present disclosure.

FIG. 2 is a plan view of the OBD II cable connector depicted in FIG. 1 connected to a scan tool in accordance with an embodiment of the present disclosure.

FIG. 3 is an alternative embodiment of an OBD II connector in accordance with an embodiment of the present disclosure.

### DETAILED DESCRIPTION

The disclosure will now be described with reference to the drawing figures, in which like reference numerals refer to like parts throughout. Various aspects of a OBD II cable and connector of the present disclosure may be illustrated by describing components that are coupled, attached, and/or joined together. As used herein, the terms “coupled”, “attached”, and/or “joined” are used to indicate either a direct connection between two components or, where appropriate, an indirect connection to one another through intervening or intermediate components.

An embodiment of the present disclosure includes an On-Board Diagnostic II (OBD II) cable connector for use with a device or tool that monitors the status of the OBD II readiness monitors of a vehicle to determine if the vehicle is “ready” for diagnostic testing and analysis. The OBD II cable connector will allow the user or operator to easily and efficiently locate the OBD II port of the vehicle via an illumination feature and assist the user in securely attaching the connector to the port via window.

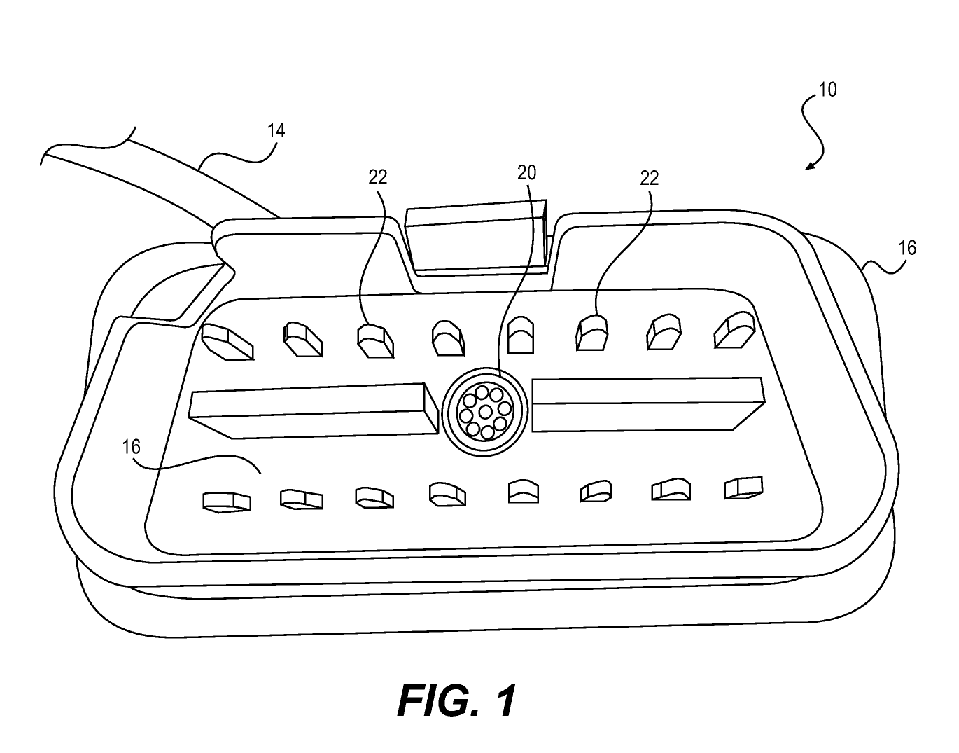

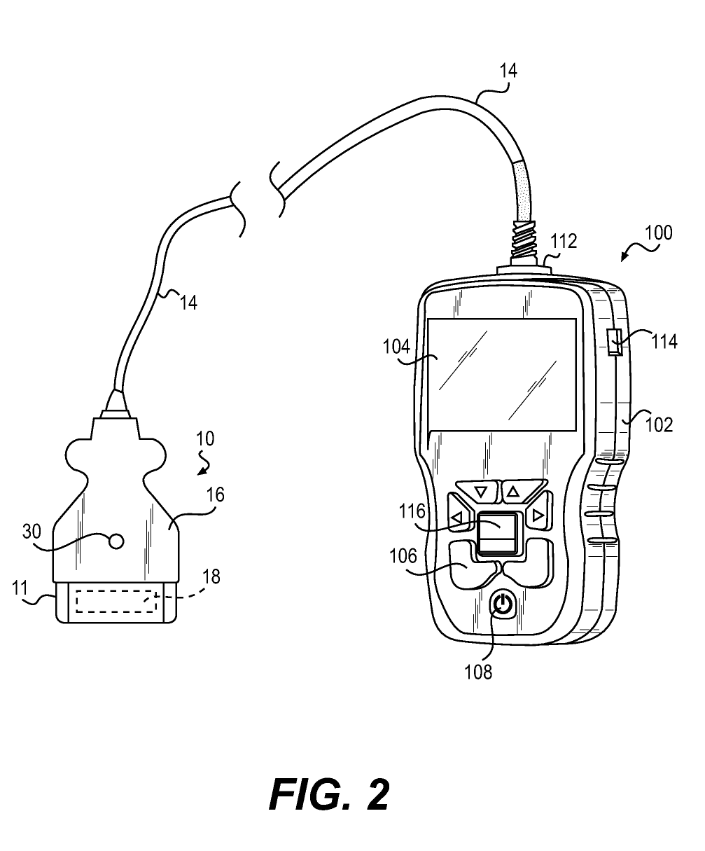

Turning now to FIGS. 1 and 2, an OBD II connector, generally designated 10, is illustrated having an interface 11 wherein the OBD II connector is connected to a diagnostic tool 100 via a cable 14. The OBD II connector 10 includes a housing 16 that retains the OBD II connector 10 components and a window or viewing slot 18 located on the interface 11. The OBD II connector 10 further includes a light source 20 preferably positioned at the center of the OBD II connector 10 flush with the connection pins 22.

Turning now specifically to FIG. 2, the diagnostic tool 100 will be preliminarily described wherein the tool 100 includes a housing 102 and a display 104. The housing 102 has an opening or connector interface 112 for coupling the cable 14 to the housing 102. The display can be any type of display, such as a liquid crystal display (LCD), that provides any type of information, such as DTCs or that the vehicle is ready or not ready for emissions testing. The cable 14 couples the diagnostic tool 100 to the OBD II connector 10 as previously described, wherein the interface 11 connects to a vehicle's onboard computer (not shown) via a port. The cable 14 can be any length desired so that it allows the OBD II connector 10 to be at any length away from the vehicle's computer as desired.

Returning to the OBD II connector 10 depicted in FIGS. 1 and 2, as previously discussed, the OBD II connector 10 includes a light source 20 located in the center of the connector 10, flush with the pins 22. When illuminated, the light source 20 allows for the operator to easily locate the OBD II port on any vehicle. This light source 20 is preferably a light emitting diode (LED) light source however any type of lighting may be utilized. Moreover, the light source 20 may alternatively employ a small light source that removably mounts or connects to the OBD II connector housing 16 and not an integral part thereof.

In another embodiment of the present disclosure, the light source 20 may operate or act as an indicator as to whether the OBD II connector 10 is securely fastened to the port on the vehicle. For example, in one embodiment, the light source 20 may illuminate or flash for a specific period of time when the OBD II connector cable 10 is securely connected to the OBD II port of the vehicle. Alternatively, in another embodiment, the light source 20 may illuminate when the diagnostic tool 100 is powered and remains illuminated until the OBD II connector 10 is securely engaged with the OBD II port vehicle when upon such time, the light source turns off.

In one embodiment of the present disclosure, the light source 20 may be powered by a small battery source (not pictured) located on the OBD II connector 10 or alternatively, powered by the diagnostic tool 100 power source. The light source 20 may be turned on and off by the switch 30 located on the housing 16 of the OBD II connector 10. Alternatively, the light source 20 may be turned on via a switch on the diagnostic tool 100 and turned off via said switch or upon connection to a vehicle.

In another embodiment of the present disclosure, instead of being controlled as described above, the light source 20 may be wired into the OBD II connector's 10 ground source. In this embodiment, when the interface 11 engages a vehicle's OBD II port, the light source 20 may automatically be turned off via a small transistor inside of the OBD II connector cable head, signaling to the use that the OBD II connector is securely attached to the automobile. Alternatively, the light source 20 may be powered by vehicle to which it is attached. For example, upon attaching the OBD II connector 10 to the vehicle, one of the pins 16 may power the light source 20.

As illustrated in FIG. 2, in one embodiment of the present disclosure, the OBD II connector 10 employs a clear window or viewing area 18 located on top of the interface 11 of the OBD II connector. This viewing window 18 may be glass, plastic or any other preferred transparent material. During operation, the window 18 allows for the operator to ensure that the light source 20 has turned off once the cable is connected to the vehicle. Moreover, the aforementioned window 18 provides the added benefit of allowing the operator confirm that the OBD II connector is securely and solidly connected to the vehicle prior to running the diagnostic analysis.

Turning now to FIG. 2 specifically, a perspective view illustrating the diagnostic tool 100 in accordance with embodiments of the present disclosure is depicted. The diagnostic tool 100 can be any analytic computing device or any other diagnostic device. The diagnostic tool 100 includes a housing 102 to house the various components of the diagnostic tool, such as a display 104, a user interface 106, a power key 108, a memory card reader (not depicted), a connector interface 112 and a data port 114. Also included in the diagnostic tool 100 is one or more microprocessors for controlling the operation of the tool and carrying out the various functionality described in this specification.

The display 104 can be any type of display, for example, a liquid crystal display (LCD), a video graphics array (VGA), a touch display (which can also be a user interface), etc. The display can turn OFF after a certain period of time that the tool is not being used. For example, when no buttons are pressed or no data has been retrieved from the vehicle for a predetermined time, for example, ten minutes, five minutes, three minutes or 1 minute, the display can automatically be shut off to conserve battery power. However, any time period can be set for turning OFF the display so that the battery (internal) can be conserved.

The user interface 106 allows the user to interact with the diagnostic tool 100 in order to operate the diagnostic tool as desired. The user interface 106 can include function keys, arrow keys or any other type of keys that can manipulate the diagnostic tool 100 in order to operate various menus that are presented on the display. In one embodiment, the diagnostic tool 100 can include a keypad test to determine if the keys are working properly. In this embodiment, the key for scroll direction is pressed to invert colors on the display. If the colors do not invert, then the key is not working properly. Other embodiments can include tests that include sound, vibration and the like to indicate if the keys are working properly.

The keys can also include a “back” or “enter” or a “code connect” key 116. Once activated, the code connect key 116 can display additional information about a diagnostic test code (DTC) or other diagnostic information as discussed herein. The input device 106 can also be a mouse or any other suitable input device, including a keypad, or a scanner. The user interface 106 can also include numbers or be alphanumeric.

The power key 108 allows the user to turn the diagnostic tool 100 ON and OFF, as required. The diagnostic tool 100 can automatically turn OFF after a user-selectable period of time of inactivity (e.g. no buttons pressed or data being collected from the vehicle). The power for the diagnostic tool 100 can be supplied from internal batteries of the tool or from the vehicle's battery when the tool is coupled to the data link connector (DLC) or from a connection to a computing device, such as through a USB connection. If the power source is the vehicle or through a connection (such as a computing device), then the tool can power on automatically once the tool is connected to the vehicle or computing device.

The memory card reader (optional) may be a single type card reader, such as a compact flash card, floppy disc, memory stick, secure digital memory, flash memory or other types of memory. The memory card reader may also be a reader that reads more than one of the aforementioned memories such as a combination memory card reader. Additionally, the memory card reader may also read any other computer readable medium, such as CD, DVD, UMD, etc. In one embodiment, the memory card reader can be used to update the software or databases that are in the diagnostic tool 100.

The connector interface 112 allows the diagnostic tool 100 to connect to an external device, such as an ECU of a vehicle, a computing device, an external communication device (such as a modem), a network, etc. through a wired or wireless connection (not shown). In addition, a data port 114 can also be included on the diagnostic tool 100 in order to connect to USB, FIREWIRE, modem, RS232, RS485, and other connections to communicate with external devices, such as a hard drive, USB drive, CD player, DVD player, UMD player, PC or other computer readable devices.

The diagnostic tool 100 can be configured additionally or alternatively to look up on-tool and/or off-tool repair assets to provide service and repair information to a user if the light source 20, for example fails to turn off upon the OBD II connector 10 being connected to a vehicle. Examples of on-tool repair assets would include repair procedures provided by the original equipment manufacturers and experience based repair information downloaded and stored to the diagnostic tool 100. Examples of the aforementioned off-tool repair assets include such assets as IATN and Direct-Hit™.

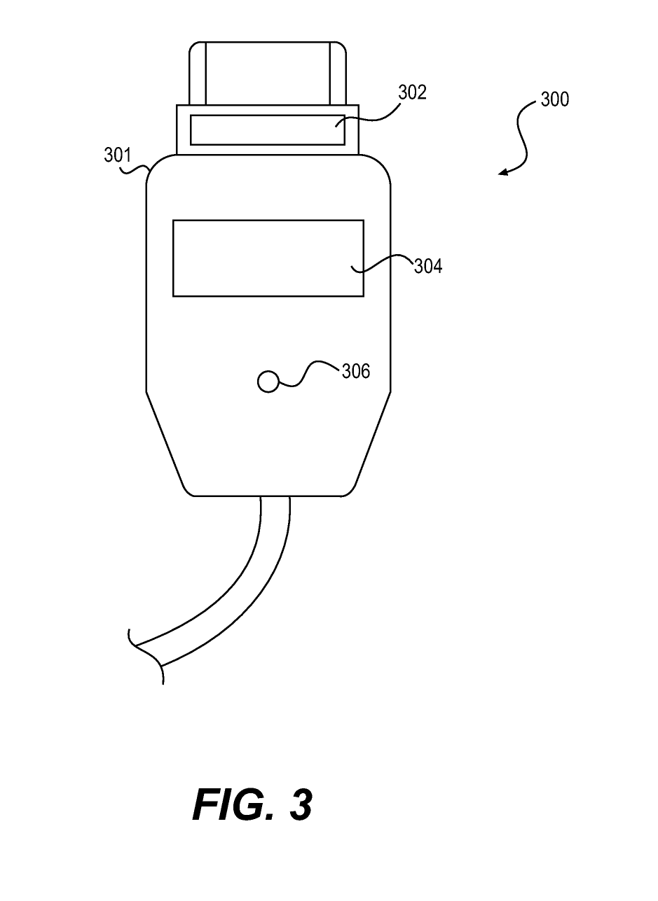

Referring now to FIG. 3, an alternative embodiment of the present disclosure is depicted showing an OBD II connector generally designated 300. As illustrated in FIG. 3, the OBD II connector 300 has a viewing slot or window 302 similar to that described in connection with the embodiment depicted in FIGS. 1 and 2. The OBD II connector 300 also includes a display 304. The display may be any type of display, for example, in one embodiment of the present disclosure, the display is liquid crystal display (LCD). In this embodiment, the display may function to indicate to the end user that the OBD II connector 300 is securely connected to the vehicle to be tested. The aforementioned indication may include wording, coloring or a combination of both. Moreover, the display 304 may provide alternative notifications to the end user when the OBD II connector 300 is being used with a diagnostic tool, providing operating indicia or the like.

Like the embodiments described previously in connection with FIGS. 1 and 2, the OBD II connector 300 may employ a light source (not pictured). The light source may be powered by a small battery source (not pictured) located on the OBD II connector 300 or alternatively, powered by a diagnostic tool to which the connector 300 is attached. The light source may be turned on and off by the switch 306 located on the housing 301 of the OBD II connector 300. Alternatively, the light source may automatically be turned on when the diagnostic tool 100 is powered up and automatically turned off when the diagnostic tool 100 is powered down.

In another embodiment of the present disclosure, instead of being controlled as described above, the light source may be wired into the OBD II connector's 300 ground source. In this embodiment, when the interface 11 engages a vehicle's OBD II connector 300, the light source may automatically be turned off via a small transistor inside of the OBD II connector cable signaling to the user that the OBD II connector 300 is securely attached to the automobile. Alternatively, the light source may be powered by vehicle to which it is attached. For example, upon attaching the OBD II connector 300 to the vehicle, one of its connection pins may power the light source.

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

What is claimed is:

1. An on board diagnostic (OBD) II cable connector for use with an automobile diagnostic tool or the like, comprising:
a housing having an interface that extends from said housing,
a series of pins extending from said interface; and
a light source disposed upon said housing.

2. The on board diagnostic (OBD) cable connector according to claim 1, further comprising a view window disposed on said housing.

3. The on board diagnostic (OBD) cable connector according to claim 1, further comprising an on board diagnostic (OBD) cable connected to said housing.

4. The on board diagnostic (OBD) cable connector according to claim 1, wherein said light source is a light emitting diode (LED).

5. The on board diagnostic (OBD) cable connector according to claim 1, further comprising a power source that powers said light source.

6. The on board diagnostic (OBD) cable connector according to claim 5, wherein said light source is configured to stay on unit a connection is made.

7. The on board diagnostic (OBD) cable connector according to claim 1, wherein said light source is integral with the interface.

8. The on board diagnostic (OBD) cable connector wherein said light source is removably attached to said housing.

9. The on board diagnostic (OBD) cable connector according to claim 1, further comprising a liquid crystal display.

10. The on board diagnostic (OBD) cable connector according to claim 1, further comprising a switch on said housing that powers said light source on and powers said light source off.

11. The on board diagnostic (OBD) cable connector according to claim 3, wherein said cable is connected to and extends from a diagnostic tool, said diagnostic tool comprising:
an input for receiving data associated with a vehicle; and
a microprocessor for processing said data received from the input.

12. A diagnostic system for running diagnostic tests or the like on a vehicle, comprising:
diagnostic tool, comprising:
an input for receiving data associated with a vehicle; and
a microprocessor for processing said data received from the input;
an on board diagnostic (OBD) cable having a connector attached to said diagnostic tool, said connector comprising:
a housing having an interface that extends from said housing,
a series of pins extending from said interface; and
a light source disposed upon said housing.

13. The diagnostic system according to claim 12, wherein said connector further comprises a view window disposed on said housing.

14. The diagnostic system according to claim 12, wherein said light source is a light emitting diode (LED).

15. The diagnostic system according to claim 12, wherein said light source is integral with the interface.

16. The diagnostic system according to claim 12, wherein said light source is removably attached to said housing.

17. The diagnostic system according to claim 12, wherein said connector further comprises a liquid crystal display.

18. The diagnostic system according to claim 12, wherein said connector, further comprises a switch on said housing that powers said light source on and powers said light source off.

19. A method for connecting an OBD II cable to an OBD II port of a vehicle, comprising:
providing an on board diagnostic (OBD) cable connector, comprising:
a housing having an interface that extends from said housing;
a series of pins extending from said interface;
a light source disposed upon said interface.
powering on said light source; and
powering off the light source when a connection is made.

20. The method according to claim 19, further comprising the step of confirming the connection via the light source.
